(19) United States
(12) Patent Application Publication
(10) Pub. No.: US 2010/0072414 A1
(43) Pub. Date: Mar. 25, 2010

(54) MICROFLUIDIC VALVE SYSTEMS AND METHODS

(75) Inventor: Jae Wan Kwon, Columbia, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE CURATORS OF THE UNIVERSITY OF MISSOURI, Columbia, MO (US)

(21) Appl. No.: 12/565,479

(22) Filed: Sep. 23, 2009

Related U.S. Application Data
(60) Provisional application No. 61/192,947, filed on Sep. 23, 2008.

(51) Int. Cl. F16K 25/00

(52) U.S. Cl. 251/368

(57) ABSTRACT

The present disclosure provides a microfluidic valve with a liquid-film-core to open and close one or more dispensing orifices of an ejection nozzle of a microfluidic system, such as an inkjet printhead, to prevent nozzle-clogging. The microfluidic valve employs a non-volatile liquid to control ambient air exposure at a liquid-air interface. Particularly, the microfluidic valve utilizes a microfluidic driving mechanism, such as electrowetting principles or magnetic fields, to control movement of the non-volatile liquid in order to control the ambient air exposure at a liquid-air interface. The valve comprises a non-volatile liquid-film-core, a valve housing including a valve channel and a pair of aligned openings, and a valve control subsystem, whereas the liquid-film-core is movably confined within the valve channel, and the valve control subsystem controls movements of the liquid-film-core within the valve channel to Open and Close the aligned openings.

### CROSS-REFERENCE TO RELATED APPLICATIONS

This application claims the benefit of U.S. Provisional Application No. 61/192,947 filed on Sep. 23, 2008. The disclosure of the above application is incorporated herein by reference in its entirety.

### FIELD

The present disclosure relates generally to microfluidic systems, such as inkjet printing systems, and more particularly to devices and methods preventing nozzle failure or orifice clogging problems in such microfluidic systems.

### BACKGROUND

Generally, microfluidic systems, such as inkjet print heads, have many internal microfluidic channels and paths connected to the ambient environment through inlet and outlet ports. Liquid materials flow through the internal microfluidic channels are dispensed from the system through an orifice, e.g., a nozzle tip. While the fluid within the system is isolated from the ambient environment, the fluid within an orifice is typically exposed to air and subject dry, thereby clogging the orifice and/or internal microfluidic channels to clog at the liquid-air interface. Often, such clogging is uncorrectable, rendering the system no longer usable. FIGS. 1(a) and 1(b) are illustrations of scanning electron microscope (SEM) pictures respectively illustrating an exemplary inkjet print head nozzle before and after clogging.

Orifice clogging, i.e., nozzle failure, effects the functionality and reliability of the respective microfluidic systems and squanders significant time and resources needed to repair or replace such microfluidic systems. For example, when the nozzle failure/orifice clogging happens to a conventional ink printer head, a costly and difficult maintenance/repair process may have to be carried out for declogging of the failed orifices. Sometimes, the clogged nozzle as well as its print head has to be replaced. Furthermore, nozzle failure and orifice clogging problems may hinder the adaptation of microfluidic systems in many biological applications, such as the droplet-on-demand technologies in drug discovery, genomics, and proteomics, or the bio-printing technologies that printing (or dispersing) biomolecules and/or bio-analytical solutions by virtue of the precise volume control and accurate positioning without contact.

### SUMMARY

Generally, in various embodiments, the present disclosure provides a method for controlling the opening and closing of an orifice of an ejection nozzle of a microfluidic system. The method employs a non-volatile and immiscible thin liquid-film-core and includes moving the thin liquid-film-core across the top surface of the ejection nozzle to close or expose the nozzle orifice. When the liquid-film-core moves to cover (close) the nozzle orifice, the liquid-film-core effectively prevents ambient air flow at the liquid-air interface of the system fluid retained within the nozzle. When the liquid-film-core moves away from (exposes) the nozzle orifice, the system fluid may be ejected from the nozzle (such as during a printing process). The movements of the liquid-film-core can be controlled by any microfluidic driving mechanism, such as electrostatic, magnetic, pressure, ultrasonic, piezoelectric, electroosmostic, thermal, or optical mechanism. In to various embodiments, electrowetting principles are employed to move the liquid-film-core, while in other embodiments magnetic forces are employed to move the liquid-film-core.

In various other embodiments, the present disclosure provides a microfluidic valve that utilizes a thin liquid-film-core to open and close an ejection nozzle orifice of a microfluidic system. The microfluidic valve comprises a pre-selected non-volatile liquid-film-core, a valve housing that includes a valve channel and a pair of openings aligned with the nozzle orifice, and a valve control subsystem that is operable to control the movements of the liquid-film-core within the valve channel to cover or expose the nozzle orifice. The valve control subsystem can be system structured and operable to control the movements of the liquid-film-core within the valve channel, e.g., an electrostatic, magnetic, pressure, ultrasonic, piezoelectric, electroosmostic, thermal, or optical based system. For example, in various embodiments, the valve control subsystem employs magnetic forces to move the liquid-film-core within the valve channel, while in other embodiments, the valve control subsystem employs electrowetting principles to move the liquid-film-core within the valve channel.

In still other embodiments, the present disclosure provides microfluidic system operable to substantially prevent drying out and clogging of system fluid within a dispensing nozzle orifice. The microfluidic system includes a microfluidic ejection nozzle and a microfluidic valve integrally disposed on or formed with the nozzle. The microfluidic valve includes a thin liquid-film-core disposed within a valve channel of a valve housing that comprises a base member having a base member orifice, a cover member having a cover member orifice, and a interstitial member having a pre-selected height. The base and cover member orifices are coaxially aligned with the nozzle orifice to enable the dispensing of the system fluid from the nozzle orifice through the cover orifice. The system additionally includes a valve control subsystem structured and operable to selectably control movements of the liquid-film-core valve channel.

### BRIEF DESCRIPTION OF DRAWINGS

FIG. 1(a) is an illustration of a scanning electron microscope (SEM) image of an exemplary inkjet print head nozzle orifice that is not clogged with dried ink.

FIG. 1(b) is an illustration of a SEM image of the exemplary inkjet print head nozzle orifice shown in FIG. 1(a) being clogged with dried ink.

FIG. 2(a) is a schematic cross-sectional longitudinal side view of a microfluidic valve in a “Closed” state disposed on a tip of a microfluidic system nozzle and exemplarily illustrating a double-side electrode configuration, in accordance with various embodiments of the present disclosure.

FIG. 2(b) is a schematic cross-sectional longitudinal side view of the microfluidic valve shown in FIG. 2(a) in an “Open” state disposed on the tip of the microfluidic system nozzle and exemplarily illustrating a single-side electrode configuration, in accordance with various embodiments of the present disclosure.

FIG. 3(a) is a schematic cross-sectional longitudinal side view of the microfluidic valve shown in FIG. 2(a), illustrating a contact angle θ of a liquid-film-core with an inner surface of valve channel of the microfluidic valve, in accordance with various embodiments of the present disclosure.

FIG. 3(b) is a schematic cross-sectional top view of the microfluidic valve shown in FIG. 2(b), in accordance with various embodiments of the present disclosure.

FIG. 4(a) is a schematic cross-sectional longitudinal side view of a microfluidic valve, such at that shown in FIG. 2(a), in a “Closed” state and structured to operate utilizing electro-magnetic forces, in accordance with various embodiments of the present disclosure.

FIG. 4(b) is a schematic cross-sectional longitudinal side view of the microfluidic valve shown in FIG. 4(a), in an “Open” state, in accordance with various embodiments of the present disclosure.

FIG. 4(c) is a schematic cross-sectional longitudinal side view of a microfluidic valve, such at that shown in FIG. 2(a), in a “Closed” state and structured to operate utilizing permanent magnets, in accordance with various embodiments of the present disclosure.

FIG. 4(d) is a schematic cross-sectional longitudinal side view of the microfluidic valve shown in FIG. 4(c), in an “Open” state, in accordance with various embodiments of the present disclosure.

FIG. 5(a) is a schematic cross-sectional lateral side view of the various microfluidic valve embodiments shown in FIGS. 2(a) through 4(b), wherein an inner surface of a cover member of the microfluidic valve includes a stabilizing groove, in accordance with various embodiments of the present disclosure.

FIG. 5(b) is a schematic cross-sectional lateral side view of the various microfluidic valve embodiments shown in FIGS. 2(a) through 4(b), wherein the inner surface of the cover member of the microfluidic valve includes a plurality of stabilizing grooves, in accordance with various other embodiments of the present disclosure.

FIG. 5(c) is a schematic cross-sectional lateral side view of the various microfluidic valve embodiments shown in FIGS. 2(a) through 4(b), wherein an inner surface of a cover member of the microfluidic valve includes a stabilizing recess, in accordance with still other embodiments of the present disclosure.

FIG. 6(a) is a schematic cross-sectional top view of a microfluidic valve, such as that shown in FIG. 2(a), in a “Closed” state, wherein a valve channel of the microfluidic valve includes a holding chamber and an elongated guiding channel, in accordance with various embodiments of the present disclosure.

FIG. 6(b) is a schematic cross-sectional top view of the microfluidic valve shown in FIG. 6(a), in an “Open” state, in accordance with various embodiments of the present disclosure.

FIG. 7(a) is a cut-away isometric view of a microfluidic valve, such as that shown in FIG. 2(a), in an “Open” state, wherein the microfluidic valve is formed as integral part of a microfluidic system nozzle, in accordance with various embodiments of the present disclosure.

FIG. 7(b) is a cut-away isometric view of a microfluidic valve shown in FIG. 7(a), in a “Closed” state, in accordance with various embodiments of the present disclosure.

FIG. 7(c) is a cross-sectional side view of a microfluidic valve, such as that shown in FIG. 2(a), in a “Closed” state, wherein the microfluidic valve is formed as integral part of a microfluidic system nozzle, in accordance with various other embodiments of the present disclosure.

FIG. 7(d) is a cross-sectional side view of a microfluidic valve shown in FIG. 7(c), in an “Open” state, in accordance with various other embodiments of the present disclosure.

FIG. 8 is a schematic cross-sectional top view of a microfluidic valve, such as that shown in FIG. 6(a), including one or more position and size sensors and a refilling port, in accordance with various embodiments of the present disclosure.

FIGS. 9(a), 9(b) and 9(c) are illustrations of pictures of a test setup for testing the feasibility of the various embodiments of the microfluidic valve shown in FIGS. 2(a) through 8.

FIG. 9(d) is an exemplary schematic diagram of the testing setup shown in FIGS. 9(a), 9(b) and 9(c).

### DETAILED DESCRIPTION

Unless otherwise defined, all technical and scientific terms used herein have the same meaning as commonly understood by one of ordinary skill in the art to which this disclosure belongs. All publications, patent applications, patents, and other references mentioned herein are incorporated by reference in their entirety.

In accordance with various embodiments of the present disclosure, a non-volatile and immiscible liquid droplet can be employed at a fluid-air interface of a nozzle orifice of a microfluidic system, e.g., an inkjet print head nozzle orifice, to prevent the evaporation and drying of a volatile system fluid, e.g., printer ink, within the nozzle orifice from which a volatile fluid is to be ejected. Generally, the non-volatile liquid forms a thin layer at the nozzle orifice and over the system fluid to protect the system fluid from ambient air exposure when the system fluid is not being ejected from the nozzle orifice. Thus, the evaporation/drying speed of the system fluid within the nozzle orifice will be significantly reduced, and the nozzle orifice will remain unclogged.

Particularly, in various embodiments, the present disclosure provides a method to prevent nozzle failure of a microfluidic system due to clogging of the nozzle orifice caused by evaporation/drying of the system fluid within the nozzle orifice is disclosed. Generally, in such embodiments, the method includes disposing a non-volatile liquid droplet material (hereafter referred to as the liquid-film or liquid-film-core), at the nozzle orifice, at or substantially near the tip of the nozzle where the system fluid would be dispensed from the nozzle during an operation of the microfluidic system and where ambient air would contact the system fluid within the nozzle orifice when system fluid is not being dispensed from the nozzle, hereafter referred to as the orifice fluid-air interface. In addition to the liquid-film-core being non-volatile, the liquid-film-core is selected to be immiscible with the system fluid.

As used herein, the terms volatile and non-volatile refer to the propensity of the respective fluid to evaporate when exposed to ambient air. For example, the system fluid is described herein as being volatile, meaning that it has a high propensity to evaporate when exposed to ambient air, while the liquid-film-core is described herein as being non-volatile, meaning that it has a very low, or no, propensity to evaporate when exposed to ambient air.

In such embodiments, the method additionally includes moving the liquid-film-core away from the fluid-air interface when the microfluidic system operated to eject the system fluid from the nozzle orifice, and moving the liquid-film-core to cover the orifice fluid-air interface when the microfluidic system is not operated to eject the system fluid from the nozzle orifice. Hence, the liquid-film-core can be positioned at the orifice fluid-air interface to seal the nozzle orifice and prevent contact of the ambient air with the system fluid retained within the nozzle.

It is envisioned that the liquid-film-core can be moved over and away from the orifice fluid-air interface by any suitable microfluidic driving mechanisms. For example, in various embodiments, the microfluidic driving mechanism can comprise an electrostatic, magnetic, pressure, ultrasonic, piezoelectric, electroosmostic, thermal, or optical mechanism. Alternatively, in other embodiments, the liquid-film-core can be selectively moved over and away from the orifice fluid-air interface utilizing electrowetting principles, wherein the liquid-film-core can be pulled away from the orifice liquid-air interface and moved to an adjacent position very quickly and precisely by attraction force from electrostatic actuation. In yet other embodiments, the liquid-film-core can be moved over and away from the orifice fluid-air interface utilizing via a set of competing magnetic forces.

More particularly, in various embodiments, the present disclosure provides a microfluidic valve operable to control the opening and closing of the microfluidic system nozzle orifice to prevent drying out of a system fluid retained in the system nozzle orifice. In various implementations, the microfluidic valve can include a pre-selected liquid-film-core disposed within a valve channel of a valve housing, wherein the valve housing further includes a pair of aligned openings that can be aligned with the system nozzle orifice to allow ejection of the system fluid. In such embodiments, the microfluidic valve can further include a control means for controlling the movement of the liquid-film-core within the valve channel to open and close the aligned openings. Particularly, the liquid-film-core is movably confined within the valve channel, while the control means controls movements of the liquid-film-core along the valve channel to open (exposing) or close (blocking) the aligned openings. For example, when the system fluid is to be ejected out through the nozzle orifice, the liquid-film-core is moved away and exposes the aligned openings to allow passages (ejections) of the system fluid. Conversely, when the system fluid is at stand-by status, i.e., retained within the nozzle orifice, the liquid-film-core is moved to block (or cover) the aligned openings, thereby sealing the system fluid within the nozzle orifice and preventing the ambient air exposure of the system fluid and preventing drying out of the system fluid within, and clogging of, the nozzle orifice.

It should be understood that the systems and methods described herein are applicable to nozzle failure due to orifice clogging of any microfluidic system without departing from the scope of the present disclosure. For example, the systems and methods described herein can be applied to inkjet printer heads while also being suitable for many biological applications, such as the droplet-on-demand technologies in drug discovery, genomics, and proteomics, or the bio-printing technologies that printing (or dispersing) biomolecules and/or bio-analytical solutions by virtue of the precise volume control and accurate positioning without contact.

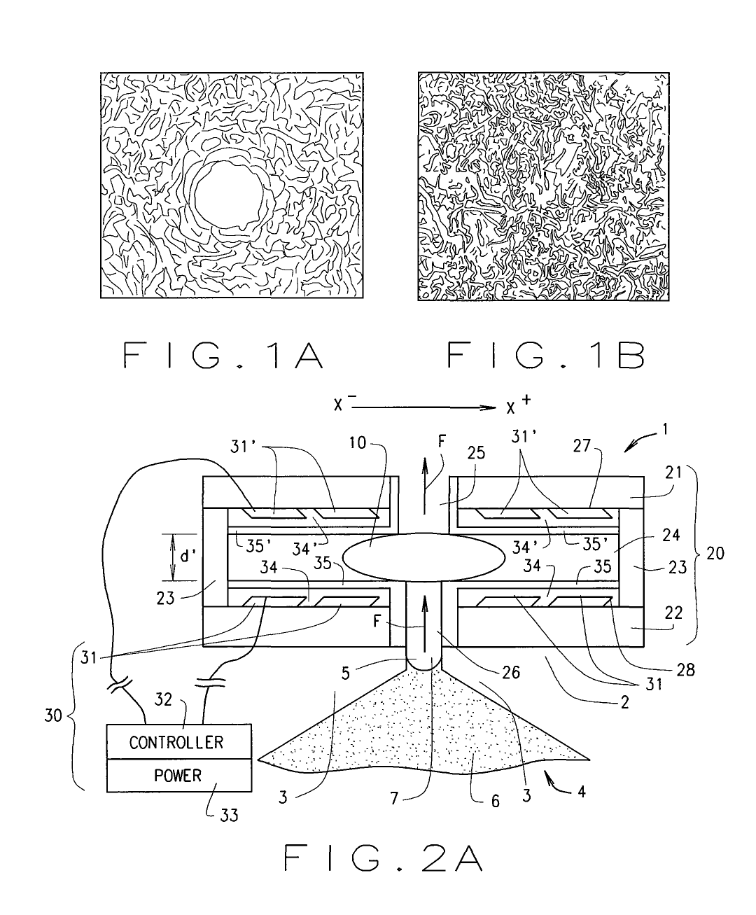

FIGS. 2(a) and 2(b) provide schematic cross-sectional views of a microfluidic valve 1, disposed on a distal end portion 2 of a fluid dispensing nozzle 3 of a microfluidic system 4, in accordance with various embodiments of the present disclosure. The microfluidic valve 1 includes a liquid-film-core 10, a valve housing 20, and a valve control subsystem 30. The valve housing 20 includes a cover member 21, a base member 22, an interstitial member 23, and a valve channel 24 formed by the cover member 21, base member 22, and interstitial member 23. The cover member 21 includes a cover orifice 25 that is coaxially aligned with a base orifice 26 included in the base member 22. The cover member 21 additionally includes inner surface 27 that faces and is adjacent an inner surface 28 of the base member 22.

As illustrated in FIGS. 2(a) and 2(b), the base member 22 of the microfluidic valve 1 is disposed on the distal end portion 2 of the microfluidic system dispensing nozzle 3 such that the base orifice 26, and hence the cover orifice 25, is coaxially aligned with a nozzle orifice 5. The microfluidic system 4 is structured to house, retain or store a quantity of system fluid 6 and dispense the system fluid 6 via the dispensing nozzle 3. Thus, system fluid is typically retained within the system nozzle 3 up to or partially within the nozzle orifice 25.

The microfluidic valve 1 is shown in FIG. 2(a) in an “Closed” state or position (sometimes referred to as the “Stand By” state or position), wherein the liquid-film-core 10 is positioned, via the valve control subsystem 30, within the valve channel 24 such that the liquid-film-core 10 blocks a fluid dispensing path, or pathway, F defined by the coaxially aligned base and cover orifices 26 and 25. More particularly, when the microfluidic valve 1 is placed in the Closed state, the liquid-film-core 10 blocks a fluid-air interface 7 formed at the nozzle orifice 5 where ambient air will contact the system fluid 6 within the nozzle orifice 5 if the fluid dispensing path F is not blocked by the liquid-film-core 10, as described herein. Accordingly, when the microfluidic valve 1 is placed in the Closed state, the liquid-film-core 10 forms a seal within the valve channel at the junction of the base orifice 26 and the cover orifice 25. Particularly, the seal formed by the liquid-film-core 10 prevents, or significantly inhibits, ambient air from contacting the system fluid 6 at the fluid-air interface 7 such that evaporation, or drying out, of the system fluid 6 retained within the nozzle orifice 5 will be prevented, or significantly retarded, thereby preventing, or significantly retarding, clogging of the nozzle orifice 5.

Conversely, the microfluidic valve 1 is shown in FIG. 2(b) in an “Open” state or position, wherein the liquid-film-core 10 is positioned, via the valve control subsystem 30, within the valve channel 24 such that the liquid-film-core 10 exposes, i.e., does not block, the fluid dispensing path F defined by the coaxially aligned base and cover orifices 26 and 25. More particularly, when the microfluidic valve 1 is placed in the Open position, the liquid-film-core 10 is positioned within the valve channel 24 to allow the system fluid 6 to be dispensed from the microfluidic system 4, and more specifically from the microfluidic valve cover orifice 25, along the fluid dispensing path F.

The liquid-film-core 10 can comprise any suitable non-volatile liquid, i.e. the evaporation speed of liquid is very slow or negligible, that is immiscible with a particular system fluid 6 retained within a microfluidic system 4. For example, various types of liquid metals, such as mercury, indalloy, etc.; organic solutions, such as silicone oil, hydrocarbon, dodecane, fomblin, etc.; or ferrofluids may be employed. The size of the liquid-film-core 10 can be pre-determined according to the surface tension of the respective liquid, the size of the base member orifice 26, and the distance d between hydrophobic layers 35 and 35′ (as shown in FIGS. 2(a) through 4(d) and described below).

Referring now to FIGS. 2(a), 2(b), 3(a), 3(b), 4(a) and, 4(b), the valve control subsystem 30 can comprise any system structured and operable to dictate the movements of the liquid-film-core 10 within the valve channel 24 utilizing electrostatic, magnetic, hydraulic, ultrasonic, piezoelectric, electroosmostic, thermal, optical, etc. principles.

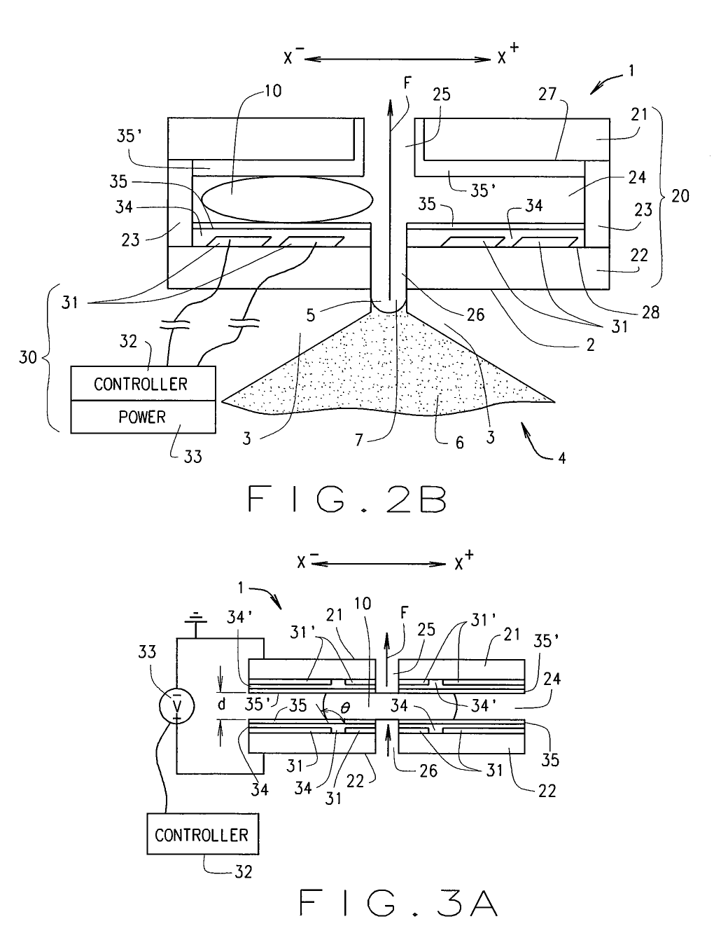

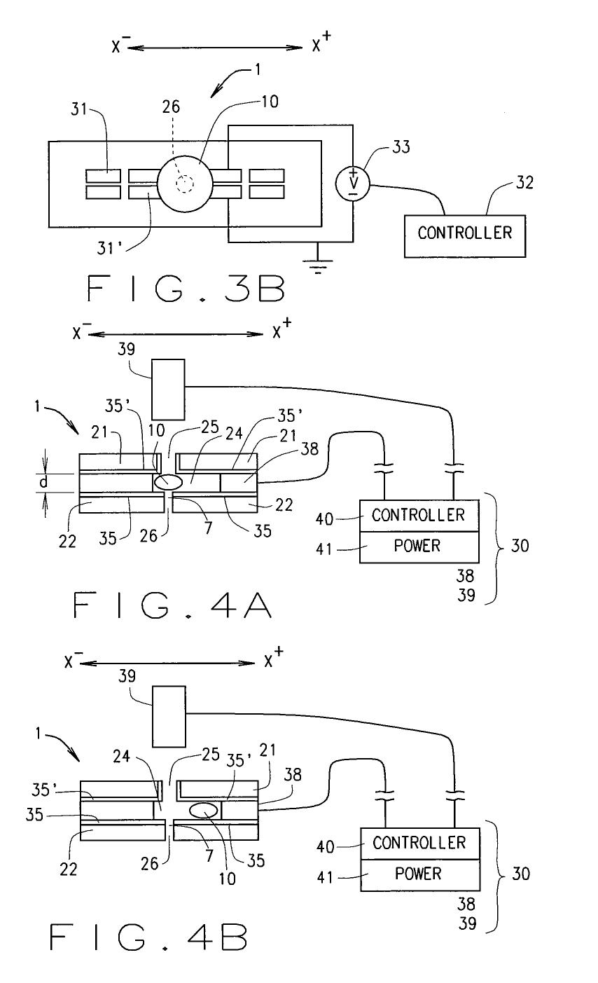

For example, as illustrated in FIGS. 2(a), 2(b), 3(a) and 3(b), in various embodiments, the liquid-film-core 10 comprises an electrically non-conductive material and electrowetting principles are employed to control the movement of the liquid-film-core 10 within the valve channel 24. In such embodiments, the valve control subsystem 30 includes one or more of electrodes 31 in electrical and/or magnetic communication with the liquid-film-core 10. In various implementations, an array of electrodes 31 are deposited in a predetermined pattern on the base member inner surface 28 and/or the cover member inner surface 27. It should be understood that the microfluidic valve 1 can include one or more electrodes 31 deposited only on the base member inner surface 28, or one or more electrodes 31 deposited only on the cover member inner surface 27 or a plurality of electrodes 31 deposited on both the inner surfaces 28 and 27.

For example, FIGS. 2(a) and 3(a) illustrate a double-sided configuration wherein a first array of electrodes 31, e.g., an array of anodes, are deposited on the base member inner surface 28 and a second array of electrodes 31′, e.g., an array of cathodes, are deposited on the cover member inner surface 27. Or, alternatively, FIGS. 2(b) and 3(b) illustrate a single-sided configuration wherein a first array of electrodes 31, e.g., an array of anodes, are deposited on a longitudinal first half of the base member inner surface 28 and a second array of electrodes 31′, e.g., an array of cathodes, are deposited on an opposing longitudinal second half of the base member inner surface 28.

In various embodiments, for conductive liquid-film-core materials (FIGS. 2(a), 2(b), 3(a) and 3(b)) the electrode(s) 31 are arranged in the patterned array within, or under, a dielectric layer 34 disposed on the base member inner surface 28 and the electrode(s) 31′ are disposed within a dielectric layer 34′ disposed on the cover member inner surface 27. The dielectric layers 34 and 34′ respectively provide electrical insulation about the electrodes 31 and 31′. Furthermore, in various embodiments (as shown in FIG. 3(a)), the microfluidic valve 1 can include a hydrophobic coating layer 35 disposed over the dielectric layer 34 of the base member 22 and a hydrophobic coating layer 35′ disposed over the dielectric layer 34′ of the cover member 21. The hydrophobic coating layers 35 and 35′ provide contact surfaces for the liquid-film-core 10 within the valve channel 24 that will not absorb or diminish the volume of the liquid-film-core 10 such that movement of the liquid-film-core 10 within the valve channel 24 is predictable and consistently controllable.

In such embodiments, the valve control subsystem 30 includes a controller 32 and a power source 33. The controller 32 can be any device operable to control the movement of the liquid-film-core 10 within the valve channel 24. For example, in various implementations the controller 32 can be a microprocessor or an application specific integrated circuit (ASIC). The power source 33 can be any device cooperative with the controller 32 to provide power for controllably energizing the electrode(s) 31 and 31′ in order to govern movement of the liquid-film-core 10 within the valve channel 24. For example, in various implementations the power source can be a direct current (DC) supply or an alternating current (AC) supply.

The controller 32 includes appropriate programming to employ electrowetting principles such that execution of such programming controls voltages between the electrodes 31 and 31′ to selectably control movement of the liquid-film-core 10 within the valve channel 24 in the X⁺ and X⁻ directions, hereafter referred to as longitudinal movement. Particularly, based on electrowetting principles, the liquid-film-core 10 can be quickly and precisely positioned over the base member orifice 26, i.e., positioned in the Closed position, to seal the orifice 26, via electrostatic attraction forces generated by application of electric fields from the power source 33 to selected electrodes 31 and 31′, as controlled by the controller 32. Similarly, the liquid-film-core 10 can be quickly and precisely pulled away from the orifice 26 and moved to the adjacent position within the valve channel 24, i.e., to the Open position, to allow the system fluid to flow along the fluid dispensing path F through the base and cover member orifices 26 and 25, via electrostatic attraction forces generated by application of electric fields from the power source 33 to other selected electrodes 31 and 31′, as controlled by the controller 32. The movement of the liquid-film-core 10 between the Open and Closed positions, as controlled by the controller 32, can be respectively synchronized with system fluid dispensing and non-dispensing operations of the microfluidic system 4.

More specifically, when an electrical potential is applied between electrodes 31 and 31′ and across the liquid-film-core 10, improved wetting is exhibited in the liquid-film-core due to a reduction in a contact angle θ (shown in FIG. 3(a)) between the liquid-film-core 10 and the base and cover member dielectric layers 34 and 34′. Or, in various embodiments, due to a reduction in the contact angle θ between the liquid-film-core 10 and the base and cover member hydrophobic coating layers 35 and 35′. This results from the lowering of solid-liquid interfacial energy through electrostatic energy stored in a capacitor formed by the liquid-film-core 10, the dielectric layers 34 and 34′ and the electrodes 31 and 31′. The dependence of the effective solid-liquid interfacial tension, γ_{SL}, on the applied voltage, V, is given according to the equation:

$${γ}_{sl} = {γ}_{sl}^{0} - \frac{ɛ {V}^{2}}{2 d} ;$$

where γ⁰ₛₗ is the interfacial tension at zero applied potential, and ∈, and d are the dielectric constant and thickness of the dielectric layers 34 and 34′, respectively. In accordance with electrowetting principles, the effect of a Debye layer in the liquid, i.e., the liquid-film-core 10, is negligible since its capacitance is connected in series with the solid insulator, i.e., the dielectric layers 34 and 34′, which typically has a much smaller capacitance.

The electrowetting effect is relatively independent of the concentration or type of ions in the liquid-film-core 10. In addition, it is desirable to use a solid dielectric material for the dielectric layers 34 and 34′ to provide larger surface energies at lower electric fields, which provides greater controllability over the surface chemistry. Since the dielectric layers 34 and 34′ play the role of the insulator, both ohmic heating and undesired electrolysis are prevented. With this basic actuation theory, various electrode patterns and layouts can be designed to achieve desired manipulation of the liquid-film-core 10.

Additionally, according to the Lippmann-Young equation, the relation between applied voltage V and the contact angle θ can be derived as:

$$cos θ - ( \frac{{γ}_{gs} - {γ}_{ls}}{{γ}_{1 g}} + \frac{{ɛ}_{s} {V}^{2}}{2 {γ}_{1 g} h} ) = 0 ;$$

where ∈ₛ, γₗₛ, γ_{gs}, γ_{lg}, h, θ are the dielectric constant of the dielectric layers 34 and 34′, liquid-solid, gas-solid, and liquid-gas interfacial tension coefficients, h is the thickness of the dielectric layers 34 and 34′, and θ is the contact angle at the triple phase, respectively.

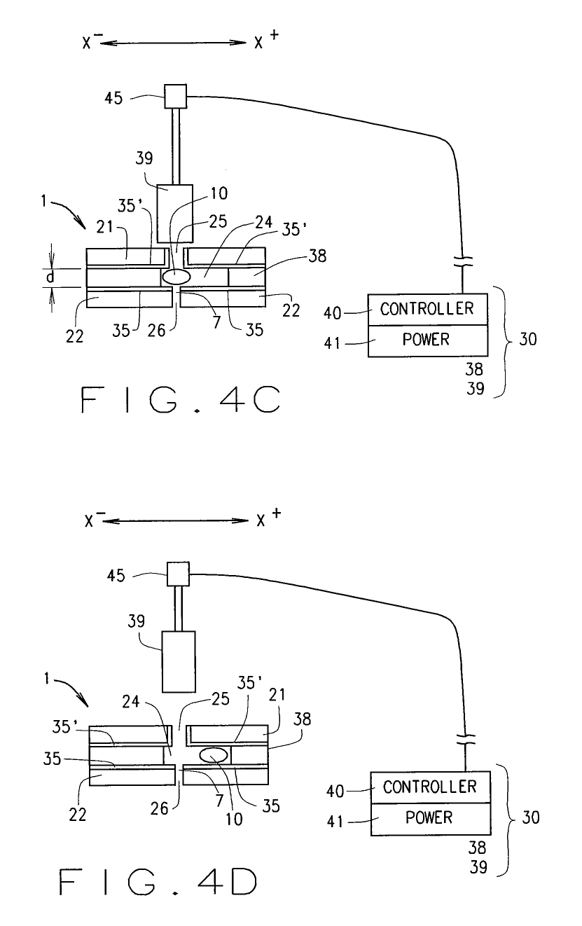

Referring now to FIGS. 4(a), 4(b), 4(c) and 4(b), in various embodiments, the liquid-film-core 10 comprises a ferrofluid and positioning of the liquid-film-core 10 is control by selectably controlled exertion of magnetic forces on the ferrofluid liquid-film-core 10. In such embodiments, the valve control subsystem 30 includes an internal magnets 38 disposed within the valve channel 24 and at one end of the valve channel 24, and an exterior magnet 39 positioned outside of the valve channel 24 adjacent the cover member orifice 25. Ferrofluids are magnetic fluids created by suspending ferromagnetic particles in a carrier fluid. Carrier fluids can be water, diesters, hydrocarbons or fluorocarbons and have a range of physical properties to serve many different applications. The properties of ferrofluids allow the liquid-film-core 10 to conform to the shape of the valve channel 24 to provide very good seals.

According to the electromagnetic field theory, the magnetic force experienced by a single paramagnetic particle in a magnetic field can be stated as:

F_{mag}=m·B;

where B is the applied magnetic flux density, m is the magnetic moment of the magnetic particle. This equation can be rewritten as:

F_{mag}=∇(m·B)=(m·∇)B+(B·∇)m

When B is large enough to saturate m, the equation reduces to:

F_{mag}≈(m·∇)B=Vχₘ(H·∇)B

Referring particularly to FIGS. 4(a) and 4(b), in various implementations, the internal and external magnets can be microfabricated electromagnets, and the valve control subsystem 30 can include a controller 40 and a power source 41. The controller 40 can be any device operable to control operation of the internal and external magnets 38 and 39 in order to control the movement of the liquid-film-core 10 within the valve channel 24. For example, in various implementations the controller 40 can be a microprocessor or an application specific integrated circuit (ASIC). The power source 41 can be any device cooperative with the controller 40 to provide power for controllably energizing the internal and external magnets 38 and 39 in order to govern movement of the liquid-film-core 10 within the valve channel 24. For example, in various implementations the power source can be a low voltage direct current (DC) supply source such as a converted alternating current (AC) feed or a battery.

Accordingly, in such implementations, the internal magnet 38 can be operated to exert an attractive force on the liquid-film-core 10, via control of the power source 41 by the controller 40. The generated attractive force pulls the ferrofluid liquid-film-core 10 toward the internal magnet 38 within the valve channel, thereby exposing the base member orifice 26, so that the system fluid 6 can be dispensed, as shown in FIG. 4(b). Subsequently, after a desired amount of system fluid 6 had been dispensed, the controller 40 controls the power source 41 such that the internal magnet 38 stops exerting an attractive force on the liquid-film-core 10. Substantially simultaneously, the external magnet 39 is operated to exert an attractive force on the liquid-film-core 10, via control of the power source 41 by the controller 40. The attractive force generated by the external magnet 39 pulls the ferrofluid liquid-film-core 10 back toward the base member orifice 26, thereby covering and sealing the base member orifice 26, and more particularly the fluid-air interface 7 such that ambient air will not contact the system fluid 6 retained within the base member orifice 26.

Referring now to FIGS. 4(c) and 4(d), alternatively, in various other implementations, the internal and external magnets 38 and 39 can be permanent magnets. In such implementations, the external magnet 39 is connected to an actuator 45 that is controlled by the controller 40 to selectively move the external magnet towards and away from the cover member orifice 25.

Accordingly, in such implementations, to place the liquid-film-core 10 in the Open position, the external magnet 39 can be moved away from the cover member orifice 25, via the actuator 45 as powered by the power source 41 and controlled by the controller 40. Thereafter, the attractive force exerted on the ferrofluid liquid-film-core 10 by the internal magnet 38 will pull the liquid-film-core 10 toward the internal magnet 38 within the valve channel 24, thereby exposing the base member orifice 26, so that the system fluid 6 can be dispensed, as shown in FIG. 4(d). Subsequently, after a desired amount of system fluid 6 had been dispensed, to move the liquid-film-core to the Closed position, the external magnet 39 can be moved toward and in close proximity to the cover member orifice 25, via the actuator 45 as powered by the power source 41 and controlled by the controller 40. As the external magnet is moved into close proximity of the cover member orifice 25, the attractive force exerted on the ferrofluid liquid-film-core 10 by the external magnet 39 will overcome the attractive force exerted on the ferrofluid liquid-film-core 10 by the internal magnet 38. Hence, the ferrofluid liquid-film-core 10 will be pulled back to the Closed position, as shown in FIG. 4(c). When in the Closed position, the liquid-film-core 10 covers and seals the base member orifice 26, and more particularly covers and seals the fluid-air interface 7 such that ambient air will not contact the system fluid 6 retained within the base member orifice 26. In such embodiments, the magnetic forces generated by the external magnet 39 are greater than the magnet forces generated by the internal magnet 38 in order to overcome the force exerted by the internal magnet 38 on the ferrofluid liquid-film-core 10.

Referring again to FIGS. 4(a), 4(b), 4(c) and 4(d), the magnetically implemented movement of the liquid-film-core 10 between the Open and Closed positions, as controlled by the controller 40, can be respectively synchronized with system fluid dispensing and non-dispensing operations of the microfluidic system 4.

Additionally, in various implementations, the microfluidic valve 1 can include a hydrophobic coating layers 35 and 35′, substantially similar to hydrophobic coating layers 35 and 35′ described above, disposed over the inner surfaces of the base and cover member 22 and 21. As described above, the hydrophobic coating layers provide contact surfaces for the liquid-film-core 10 within the valve channel 24 that will not absorb or diminish the volume of the liquid-film-core 10 such that movement of the liquid-film-core 10 within the valve channel 24 is predictable and consistently controllable.

Referring now to FIGS. 2(a) through 4(b), it is envisioned that the base member 22 and the cover member 21 can be fabricated of any material that is non-reactive with the system fluid 6 and the liquid-film-core 10. Additionally, the distance d between the dielectric layers 34 and 34′ or between the hydrophobic layers, e.g., hydrophobic layers 35 and 35′ is pre-determined for a particular application. In various embodiments, the diameter of the base member orifice 26 can be substantially equal to the diameter of the system nozzle orifice 5, while the diameter of the cover member orifice 25 can be slightly larger that the diameter of the base member orifice 26 to avoid the obstruction to the fluid dispensing path F.

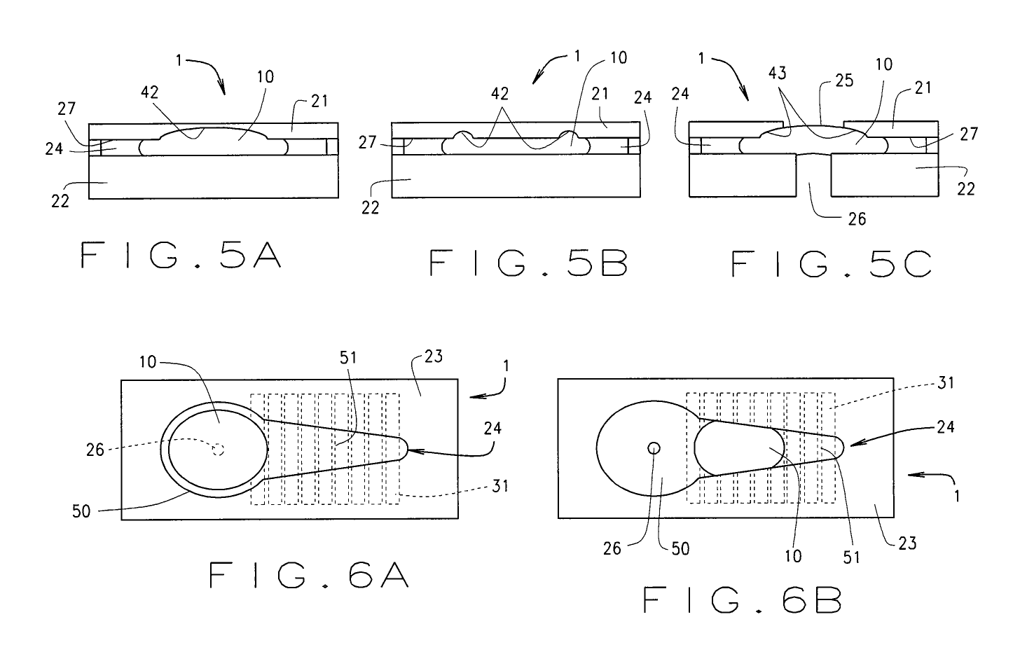

Referring now to FIGS. 5(a) and 5(b), in various embodiments, the cover member inner surface 27 can be structured to enhance the stability of the liquid-film-core 10 within the valve channel 24. Particularly, the cover member inner surface 27 can include one or more longitudinal stabilizing grooves 42 into which the liquid-film-core 10 will protrude, or conform. Accordingly, as the liquid-film-core 10 is moved longitudinally along the valve channel 24 between the Closed and Open positions, the longitudinal stabilizing groove(s) 42 serve(s) as stabilizing tracks that deter lateral movement of the liquid-film-core 10 within the valve channel 24.

Referring now to FIG. 5(c), in various embodiments, the cover member inner surface 27 can be structured to enhance the stability of the liquid-film-core 10 in the Closed position, i.e., at the base member orifice 26. Particularly, the cover member inner surface 27 can include a stabilizing recess 43 centered at the cover member orifice 25 into which the liquid-film-core 10 will protrude, or conform when placed in the Closed position. Accordingly, the stabilizing recess 43 serves to stabilize the liquid-film-core 10 in the Closed position to provide a more stable seal at the base member orifice 26.

Additionally, it is envisioned that the lateral cross-section of the valve channel 24, i.e., a cross-section orthogonal to the longitudinal movement of the liquid-film-core within the valve channel 24 as described above, can have any suitable shape. For example, in various embodiments, the valve channel 24 can have a substantially rectangular lateral cross-section, as shown in FIGS. 5(a), 5(b) and 5(c). Or, in various other embodiments, the valve channel 24 can have a triangular lateral cross-section, or an oval lateral cross-section, or any other lateral cross-section suitable to confine the liquid-film-core 10 to longitudinal movement between the Closed and Open positions, as described above. It is also envisioned that locally different surfaces (i.e., a combination of hydrophobic and hydrophilic surfaces) can be employed to enhance the stability of the liquid-film-core 10 within the valve channel 24.

Referring now to FIGS. 6(a) and 6(b), in various embodiments, the interstitial member 23 can be structured to provide the valve channel 24 such that the valve channel 24 includes a holding chamber 50 connected to an elongated guiding duct 51. The base member orifice 26 is centrally located within the holding chamber 50. If movement of the fluid-film-core 10 is controlled via electrowetting principles, as described above, the electrodes are deposited on the base member and/or cover member inners surface 28 and/or 27 adjacent the elongated guiding duct 51. The holding chamber 50 is structured to provide position stability of the fluid-film-core 10 to substantially center the fluid-film-core 10 over the base member orifice 26 when in the Closed position. The elongated guiding duct 51 is structured to provide lateral stability of the fluid-film-core 10 as the fluid-film-core 10 is moved to and from the Open position.

FIGS. 2(a) through 6(b) illustrate the microfluidic valve 1 as being independent from the microfluidic system 4, wherein that the microfluidic valve 1 is structured to be disposed or, e.g., attached to, the microfluidic system nozzle 3.

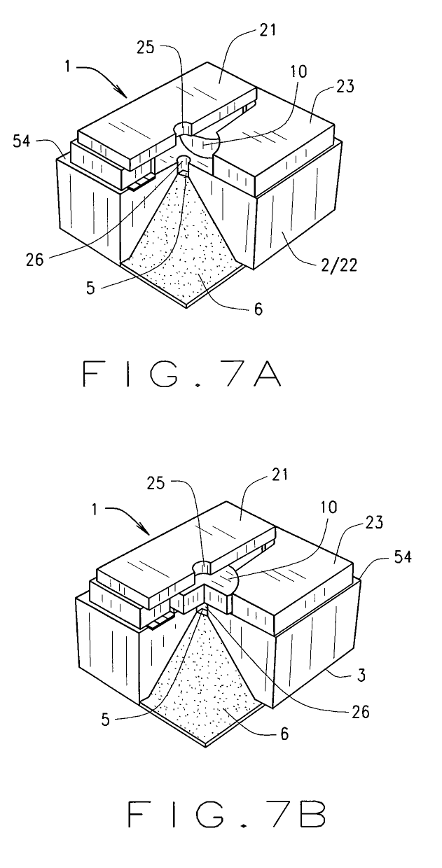

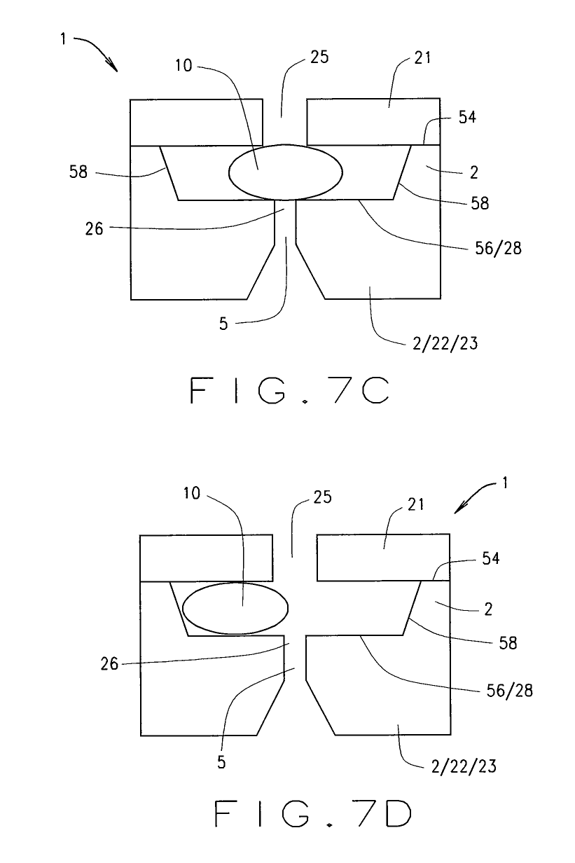

However, as illustrated in FIGS. 7(a), 7(b), 7(c) and 7(d), in various embodiments, the microfluidic valve 1 can be formed as an integral part of the microfluidic system nozzle 3.

For example, as illustrated in FIGS. 7(a) and 7(b), in various embodiments, the base member 22 is not present and the interstitial member 23 is disposed directly on a distal surface 54 of the microfluidic system nozzle distal end portion 2. Therefore, in such embodiments, the microfluidic system nozzle distal end portion 2 provides the base member 22 and a distal surface 54 of the microfluidic system nozzle distal end portion 2 provides the base member inner surface 28. Moreover, electrodes and a dielectric layer and/or a hydrophobic coating layer can be disposed on the microfluidic system nozzle distal surface 54 in the same manner the electrodes 31, dielectric layer 34 and/or hydrophobic coating layer 35 is/are disposed on the base member inner surface 28, as described above. In such embodiments, the interstitial member 23 and cover member 21 can be structured and operable in substantially the same manner as described above with regard to FIGS. 2(a) through 6(b). Accordingly, the integrally formed microfluidic valve 1 shown in FIGS. 7(a) and 7(b) can be structured to function in substantially the same manner as described above with regard to FIGS. 2(a) through 6(b).

Alternatively, as illustrated in FIGS. 7(c) and 7(d), in various embodiments, the base member 22 and the interstitial member 23 are not present and the cover member 21 is be disposed directly on the distal surface 54 of the microfluidic system nozzle distal end portion 2. Additionally, the of microfluidic system nozzle distal end portion 2 is recessed to form the valve channel 24. Therefore, in such embodiments, the microfluidic system nozzle distal end portion 2 provides the base member 22 and a bottom surface 56 of the recessed valve channel 24 provides the base member inner surface 28. Additionally, a sidewall 58 of the recessed valve channel 24 provides the interstitial member 23.

Accordingly, electrodes and a dielectric layer and/or hydrophobic coating layer can be disposed on the recessed valve channel bottom surface 56 in the same manner the electrodes 31 and dielectric layer 34 and/or the hydrophobic coating layer 35 is/are disposed on the base member inner surface 28, as described above. Additionally, the sidewall 58 can be structured such that the recessed valve channel 24 provides all the features and function of the valve channel 24 described above with regard to FIGS. 2(a) through 6(b). Furthermore, in such embodiments, the cover member 23 can be structured and operable in substantially the same manner as described above with regard to FIGS. 2(a) through 6(b). Accordingly, the integrally formed microfluidic valve 1 shown in FIGS. 7(c) and 7(d) can be structured to function in substantially the same manner as described above with regard to FIGS. 2(a) through 6(b).

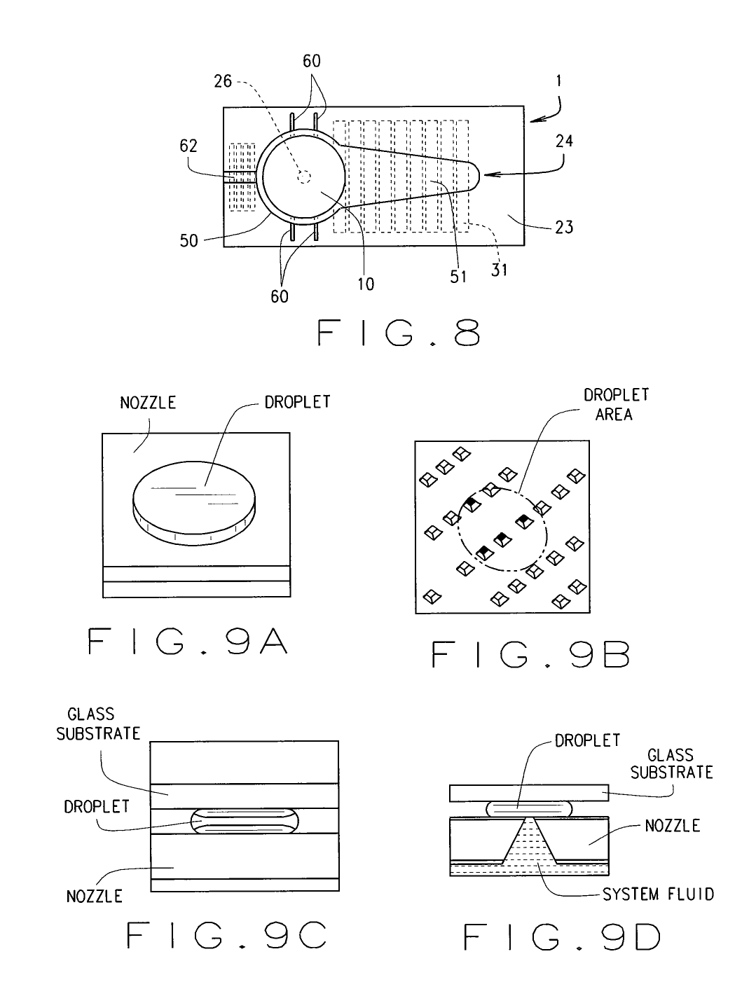

Referring now to FIG. 8, in various embodiments, the microfluidic valve 1 can further include one or more sensors, or a sensing array, 60 to monitor the size, position and/or movements of the liquid-film-core 10. In such embodiments, the sensor(s) 60 is disposed in the valve channel 24 laterally adjacent the base member orifice 26 such that the sensor(s) 60 can detect when the fluid-film-core 10 is properly located over the base member orifice 26, when in the Closed position, and when the fluid-film-core 10 is properly located away from the base member orifice 26, when in the Open position. Additionally, the sensors can be operable to sense any diminution in the size of the fluid-film-core 10, which could lead to functional inefficiency of the microfluidic valve 1. The sensor(s) can comprise and suitable sensor such as capacitive or resistive sensors.

Additionally, in various embodiments, the microfluidic valve 1 can further include a refilling port 62 structured and operable to allow liquid-film-core material to be added to the liquid-film-core 10. For example, if the sensors 60 detect that the liquid-film-core 10 has decreased in volume/size, additional liquid-film-core material can be introduced into the valve channel 24, via the refilling port 62. Accordingly, the additional liquid-film-core material will combine with the liquid-film-core 10 and increase the volume/size of the liquid-film-core 10 such that a substantially constant volume of the liquid-film-core 10 can be maintained.

Referring now to FIGS. 9(a), 9(b), 9(c) and 9(d), evaluation of the feasibility of the microfluidic valve 1, as described above, will now be described. The stability of the liquid-film-core 10 was tested by placing a liquid droplet on top of a plurality of orifices of a microfluidic system nozzle, e.g., a print head nozzle, and sandwiching the droplet with a top glass substrate. FIG. 9(d) is an exemplary schematic diagram of the testing setup, with the liquid droplet sandwiched between the top surface of a nozzle and the inner surface of a cover glass. As illustrated, the liquid droplet covers a nozzle orifice (only a single orifice is illustrated in FIG. 9(d)), which is holding the microfluidic system fluid, e.g., printer ink.

In the particular study, a drop of mercury (a liquid metal) was placed on top of an array of small orifices, each having a diameter of about 100 microns, and the gap distance between the top surface of the nozzle and the inner surface of the cover glass was about 300 microns. FIGS. 9(a), 9(b) and 9(c) are illustrations of pictures of testing setup with a liquid droplet on top of an orifice array. Particularly, FIG. 9(a) is the top view, FIG. 9(b) the bottom view with a circle indicating the droplet area, and FIG. 9(c) the side view. As shown in FIG. 9(a), the mercury droplet spreads and turns into a circular thin liquid film having approximately a 4 mm diameter. As shown in FIGS. 9(b) and 9(c), the mercury film covers over the orifice area completely, while importantly the liquid film is stable. That is, the mercury film retains its shape and does not lose volume by dropping down into the nozzle orifices.

Testing also considered the bulge-up effect of a liquid droplet, i.e., a liquid-film such as liquid-film-core 10, sandwiched between the two substrates with openings, and found that by controlling the gap distance between the two substrates with openings, with respect to the radius of the orifices, the surface tensions, the contact angle of the liquid-film and the surface composition of the nozzle, bulging up of the liquid-film can be prevented or adjusted.

Particularly, a simple bulge-up test at an opening in a glass substrate was done. A glass with 1 mm diameter hole was place on top of a mercury drop disposed on a base substrate, and the gap distance between glass and base substrates was set at about 300 microns. The gap distance was then systematically reduces and as the gap distance is reduced, the liquid metal in the opening was bulged up more and more and when the gap distance was smaller than a certain threshold level, liquid drop escaped out of the hole in the glass substrate.

The bulging at the orifice area is caused by the pressure imbalance within a liquid drop in accordance with the nozzle, orifice and gap geometries, which is given by the following equation:

$$Δ P = {P}_{ch} - {P}_{noz} \geq {γ}_{LG} ( - \frac{2 cos {θ}_{c}}{d} + \frac{1}{{R}_{liq}} - \frac{4}{D} ) ;$$

where P_{ch}, P_{noz}, γ_{LG}, θ_{c}, R_{kiq}, d, are the pressure inside of liquid in the gap and the pressure at the nozzle, the surface tension at the interface of liquid and solid, the contact angle, the radius of the liquid droplet, and the gap distance respectively, and D represents the radius of the nozzle orifice. According to the expression, when d<<D, P_{ch} gets bigger than P_{noz}. Thus, the liquid tends to bulge out through the orifice. When the gap size gets close to the orifice radius or the radius of the orifice in the cover changes, the pressure inside the liquid film in the gap (P_{ch}) drops lower than the pressure at the nozzle side (P_{noz}). It also indicates that contact angle and surface tension also affect the pressure relationship. This result gives very important information for the successful valve design.

Experimentation also compared the evaporation speeds of a system fluid in the orifice before and after ejection by covering the orifice with a liquid-film, and found that the evaporation speed decreases significantly after covering. The experiments tested the evaporation speeds of water (a common solvent in an inkjet printer fluid) retained within a microfluidic system chamber before and after closing an orifice to the chamber with mercury droplet. Without the blocking of the orifice, water in the chamber evaporated completely in approximately 5 min. However, with a closed orifice, volume reduction of the water was not noticed even after a few hours.

Hence the present disclosure provides a microfluidic valve that incorporates a liquid-film-core to control the opening and closing of an ejection nozzle orifice of a microfluidic system. Closing the nozzle orifice using the liquid-film-core prevents prolonged air exposure of system fluid retained within the orifice, and thereby substantially eliminates drying out/evaporation of the system fluid and clogging of the orifice. The disclosed microfluidic valve also prevents stiction problems commonly encountered with conventional solid microstructure-based valve system.

While the disclosure has been described in connection with specific embodiments thereof, it will be understood that the inventive methodology is capable of further modifications. This patent application is intended to cover any variations, uses, or adaptations of the disclosure following, in general, the principles of the disclosure and including such departures from the present disclosure as come within known or customary practice within the art to which the disclosure pertains and as may be applied to the essential features herein before set forth and as follows in scope of the appended claims.

What is claimed is:

1. A microfluidic valve structured and operable to selectively cover and uncover a microfluidic system fluid dispensing nozzle orifice, said valve comprising:
a valve housing disposed at a fluid dispensing orifice of a microfluidic system dispensing nozzle, the valve housing comprising a fluid dispensing pathway through which a system fluid dispensed from the dispensing nozzle can flow and a valve channel that intersects the fluid dispensing pathway;
a liquid-film-core movably disposed within the valve channel, the liquid-film-core comprising a substantially non-volatile liquid that is substantially immiscible with the system fluid; and
valve control subsystem structured and operable to control movement of the liquid-film-core within the valve channel to selectively close and open the dispensing pathway, thereby selectively covering and uncovering the fluid dispensing orifice.

2. The valve of claim 1, wherein the valve housing further comprises:
a base member comprising a distal end portion of the dispensing nozzle and having a base member orifice;
a cover member having a cover member orifice; and
an interstitial member structured to define the valve channel and to join the base and cover members such that the base member orifice and the cover member orifice are substantially coaxially aligned, whereby the coaxially aligned base and cover member orifices form the fluid dispensing pathway.

3. The valve of claim 2, wherein the valve control subsystem comprises:
a plurality of electrodes disposed on at least one of an inner surface of the base member and an inner surface of the cover member such that the electrodes are in electrostatic communication with the liquid-film-core;
a power source electrically connected to the electrodes; and
a controller operable to control application of electrical fields from the power source to selected pairs of electrodes to generate electrostatic fields that cause the liquid-film-core to move within the valve channel to selectively close and open the dispensing pathway.

4. The valve of claim 3, wherein the electrodes are disposed within a dielectric layer disposed on the respective at least one of the base member inner surface and the cover member inner surface, and the valve housing further comprises a hydrophobic coating layer disposed on one of:
each of the dielectric layers, when both the base and cover members have the electrodes and dielectric layers disposed thereon;
the dielectric layer and opposing base member or cover member inner surface, when only one of the base and cover members have the electrodes and dielectric layer disposed thereon;

5. The valve of claim 2, wherein valve control subsystem comprises:
an internal magnet disposed within and at an end of the valve channel;
an external magnet disposed external to the cover member and adjacent the cover member orifice;
a power source electrically connected to the internal and external magnets; and
a controller operable to control application of electrical current from the power source to the internal and external magnets to selectively generate magnetic fields that cause the liquid-film-core to move within the valve channel to selectively close and open the dispensing pathway.

6. The valve of claim 5, wherein valve housing further comprises a hydrophobic coating layer disposed on each of the base and cover member inner surfaces.

7. The valve of claim 2, wherein valve control subsystem comprises:
an internal permanent magnet disposed within and at an end of the valve channel;
an external permanent magnet disposed external to the cover member and adjacent the cover member orifice, and coupled to an actuator operable to move the external permanent magnet toward and away from the cover member orifice, the external permanent magnet generating a magnetic field that is greater than a magnetic field generated by the internal permanent magnet;
a power source electrically connected to the actuator; and
a controller operable to control application of electrical current from the power source to the actuator to selectively move the external permanent magnet toward and away from the cover member orifice to cause the liquid-film-core to move within the valve channel to selectively close and open the dispensing pathway.

8. The valve of claim 2, wherein the interstitial member is structured to define the valve channel such that the valve channel includes:
a holding chamber structured to stabilize the fluid-film-core over the base member orifice when the fluid-film-core is in an Closed position; and
an elongated guide duct structured to provide lateral stability of the fluid-film-core as the fluid-film-core is moved to and from an Open position.

9. The valve of claim 2, wherein the valve housing further comprises one of:
one or more stabilizing grooves formed in the cover member inner surface into which the liquid-film-core protrudes such that as the liquid-film-core is moved longitudinally along the valve channel the one or more stabilizing grooves serve as one or more stabilizing tracks that deter lateral movement of the liquid-film-core within the valve channel;
and stabilizing recess formed in the cover member inner surface and centered at the cover member orifice into which the liquid-film-core will protrude to stabilize the liquid-film-core when the liquid-film-core is positioned over the base member orifice; and
a stabilizing coating disposed between the liquid-film-core and the cover member inner surface, wherein particular portions of the stabilizing coating comprise a hydrophobic coating and other particular portions of the stabilizing coating comprise a hydrophilic coating, thereby providing a combination of locally different surfaces that are operable to stabilize the movement and positioning of the liquid-film-core within valve channel.

10. A method for selectively covering and uncovering a microfluidic system fluid dispensing nozzle orifice utilizing a microfluidic valve, said method comprising:
disposing a valve housing at a fluid dispensing orifice of a dispensing nozzle a microfluidic system, the valve housing comprising:
a base member comprising a distal end portion of the dispensing nozzle and having a base member orifice, a cover member having a cover member orifice, and an interstitial member structured to define a valve channel between the base and cover members and to join the base and cover members such that the base member orifice and the cover member orifice are substantially coaxially aligned, whereby the coaxially aligned base and cover member orifices form a fluid dispensing pathway that intersect the valve channel and through which a system fluid dispensed from the dispensing nozzle can flow, the valve channel having a liquid-film-core movably disposed therein that comprises a substantially non-volatile liquid that is substantially immiscible with the system fluid; and
providing a valve control subsystem structured and operable to control movement of the liquid-film-core within the valve channel to selectively close and open the dispensing pathway, thereby selectively covering and uncovering the fluid dispensing orifice.

11. The method of claim 10, wherein providing a valve control subsystem comprises:
disposing a plurality of electrodes on at least one of an inner surface of the base member and an inner surface of the cover member such that the electrodes are in electrostatic communication with the liquid-film-core; and
controlling application of electrical fields from a power source to selected pairs of electrodes to generate electrostatic fields that cause the liquid-film-core to move within the valve channel to selectively close and open the dispensing pathway.

12. The method of claim 11, providing a valve control subsystem further comprises:
disposing the electrodes within a dielectric layer disposed on the respective at least one of the base member inner surface and the cover member inner surface; and
disposing a hydrophobic coating layer on one of:
each of the dielectric layers, when both the base and cover members have the electrodes and dielectric layers disposed thereon; and
the dielectric layer and opposing base member or cover member inner surface, when only one of the base and cover members have the electrodes and dielectric layer disposed thereon.

13. The method of claim 10, providing a valve control subsystem comprises:
disposing an internal magnet within and at an end of the valve channel;
disposing an external magnet external to the cover member and adjacent the cover member orifice; and
controlling application of electrical current from a power source to the internal and external magnets to selectively generate magnetic fields that cause the liquid-film-core to move within the valve channel to selectively close and open the dispensing pathway.

14. The method of claim 13, wherein providing a valve control subsystem further comprises disposing a hydrophobic coating layer on each of the base and cover member inner surfaces.

15. The method of claim 10, wherein providing a valve control subsystem comprises:
disposing an internal permanent magnet within and at an end of the valve channel;
disposing an external permanent magnet external to the cover member and adjacent the cover member orifice, wherein the external permanent magnet is coupled to an actuator operable to move the external permanent magnet toward and away from the cover member orifice, the external permanent magnet generating a magnetic field that is greater than a magnetic field generated by the internal permanent magnet; and
controlling application of electrical current from a power source to the actuator to selectively move the external permanent magnet toward and away from the cover member orifice to cause the liquid-film-core to move within the valve channel to selectively close and open the dispensing pathway.

16. The method of claim 10, wherein disposing a valve housing on the dispensing nozzle comprises utilizing a distal end portion of the microfluidic system dispensing nozzle as the base member such that the housing is integrally formed with the dispensing nozzle.

17. A microfluidic valve structured and operable to selectively cover and uncover a microfluidic system fluid dispensing nozzle orifice, said valve comprising:
a valve housing structured to be disposed at a fluid dispensing orifice of the dispensing nozzle of a microfluidic system, the valve housing comprising:
a base member having a base member orifice, a cover member having a cover member orifice, and an interstitial member structured to define a valve channel between the base and cover members and to join the base and cover members such that the base member orifice and the cover member orifice are substantially coaxially aligned, whereby the coaxially aligned base and cover member orifices form a fluid dispensing pathway that intersect the valve channel and through which a system fluid dispensed from the dispensing nozzle can flow, the valve channel having a liquid-film-core movably disposed therein that comprises a substantially non-volatile liquid that is substantially immiscible with the system fluid;
a liquid-film-core movably disposed within the valve channel, the liquid-film-core comprising a substantially non-volatile liquid that is substantially immiscible with the system fluid; and
valve control subsystem structured and operable to control movement of the liquid-film-core within the valve channel to selectively close and open the dispensing pathway, thereby selectively covering and uncovering the fluid dispensing orifice.

18. The valve of claim 17, wherein valve control subsystem comprises:
a plurality of electrodes disposed on at least one of an inner surface of the base member and an inner surface of the cover member such that the electrodes are in electrostatic communication with the liquid-film-core;
a power source electrically connected to the electrodes; and
a controller operable to control application of electrical fields from the power source to selected pairs of electrodes to generate electrostatic fields that cause the liquid-film-core to move within the valve channel to selectively close and open the dispensing pathway.

19. The valve of claim 18, wherein the electrodes are disposed within a dielectric layer disposed on the respective at least one of the base member inner surface and the cover member inner surface, and the valve housing further comprises a hydrophobic coating layer disposed on one of:
each of the dielectric layers, when both the base and cover members have the electrodes and dielectric layers disposed thereon; and
the dielectric layer and opposing base member or cover member inner surface, when only one of the base and cover members have the electrodes and dielectric layer disposed thereon.

20. The valve of claim 17, wherein valve control subsystem comprises:
an internal magnet disposed within and at an end of the valve channel;
an external magnet disposed external to the cover member and adjacent the cover member orifice;
a power source electrically connected to the internal and external magnets; and
a controller operable to control application of electrical current from the power source to the internal and external magnets to selectively generate magnetic fields that cause the liquid-film-core to move within the valve channel to selectively close and open the dispensing pathway.

21. The valve of claim 20, wherein valve housing further comprises a hydrophobic coating layer disposed on each of the base and cover member inner surfaces.

22. The valve of claim 17, wherein valve control subsystem comprises:
an internal permanent magnet disposed within and at an end of the valve channel;
an external permanent magnet disposed external to the cover member and adjacent the cover member orifice, and coupled to an actuator operable to move the external permanent magnet toward and away from the cover member orifice, the external permanent magnet generating a magnetic field that is greater than a magnetic field generated by the internal permanent magnet;
a power source electrically connected to the actuator; and
a controller operable to control application of electrical current from the power source to the actuator to selectively move the external permanent magnet toward and away from the cover member orifice to cause the liquid-film-core to move within the valve channel to selectively close and open the dispensing pathway.

23. The valve of claim 17, wherein the base member comprises a distal end portion of the microfluidic system dispensing nozzle such that the housing is integrally formed with the dispensing nozzle.
